(19) United States
(12) Patent Application Publication
(10) Pub. No.: US 2025/0388771 A1
(43) Pub. Date: Dec. 25, 2025

(54) INK SET FOR THERMAL TRANSFER SHEET, THERMAL TRANSFER SHEET, METHOD FOR PRODUCING THERMAL TRANSFER SHEET, AND METHOD FOR PRODUCING TRANSFER PRINTED MATTER

(71) Applicant: RISO KAGAKU CORPORATION, Tokyo (JP)

(72) Inventor: Akiko HAYASHI, Tokyo (JP)

(21) Appl. No.: 19/226,657

(22) Filed: Jun. 3, 2025

(30) Foreign Application Priority Data
Jun. 20, 2024 (JP) 2024-099686

(51) Int. Cl. C09D 11/40; B41M 5/34; B41M 5/382; B41M 5/385; B41M 5/44; C09D 11/322; C09D 11/324; C09D 11/54; D06P 5/24

(52) U.S. Cl. CPC C09D 11/40; B41M 5/345; B41M 5/38228; B41M 5/3858; B41M 5/44; C09D 11/322; C09D 11/324; C09D 11/54; D06P 5/003; B41M 2205/38

(57) ABSTRACT

An ink set for a thermal transfer sheet, comprising: a white ink; and a color ink having a color other than white, wherein the white ink contains a water-dispersible resin (A) and water, and the water-dispersible resin (A) has a thermal melting temperature of 100° C. or lower.

### CROSS REFERENCE TO RELATED APPLICATIONS

This application is based upon and claims the benefit of priority from the prior Japanese Patent Application No. 2024-099686, filed on Jun. 20, 2024, the entire contents of which are incorporated by reference herein.

### BACKGROUND OF THE INVENTION

### Field of the Invention

The disclosure relates to an ink set for a thermal transfer sheet, a thermal transfer sheet, a method for producing a thermal transfer sheet, and a method for producing a transfer printed matter.

### Description of the Related Art

In recent years, DTF printing has gained attention as a method for printing images such as letters, pictures, and designs on fabrics such as woven fabrics, knitted fabrics, or non-woven fabrics. DTF stands for Direct To Film, specifically referring to a printing method using thermal transfer sheets. Thermal transfer sheets for DTF printing are generally produced by color printing a desired image on a substrate sheet, printing a white ink over the image, applying a hot melt powder onto the wet white ink, and heating to melt the hot melt powder. Printing on fabric is performed by placing a hot melt powder layer of the thermal transfer sheet against the fabric side and transferring the image by heat pressing. DTF printing has advantages such as higher image clarity and wider selections of colors and types of printable fabrics compared to direct printing on fabric.

As a prior art related to DTF printing, JP 2019-171840 A (also referred to as Patent Document 1) describes an example of using a grade of resin powder that is heat-meltable and adheres without gaps over the entire surface of the ink, specifically a grade of resin powder with a particle size of 75 μm or less accounting for 87% or more, and not containing powder with a particle size exceeding 150 μm, along with a transfer sheet having non-permeability of the ink sufficient to maintain the adhesion of the resin powder, to provide a transfer printing method capable of printing without image lack.

As described in Patent Document 1, one of the technical challenges faced by DTF printing is to form a transfer image without lack. In the method described in Patent Document 1, in order to prevent image lack, a special grade of hot melt powder is used along with a highly non-permeable substrate sheet to ensure the adhesion of the hot melt powder, but there is a problem that the preferred grade of hot melt powder has a small particle size and is prone to scattering, making it difficult to handle. Additionally, since the method uses a highly non-permeable substrate sheet, color mixture between the color ink used to form the image and the white ink applied over it can easily occur, which lowers image reproducibility, presenting another problem.

An object of the disclosure is to provide a thermal transfer sheet with excellent image transferability, an ink set for a thermal transfer sheet, a method for producing a thermal transfer sheet, and a method for producing a transfer printed matter.

### SUMMARY OF THE INVENTION

One embodiment of the disclosure is an ink set for a thermal transfer sheet, comprising: a white ink; and a color ink having a color other than white, wherein the white ink contains a water-dispersible resin (A) and water, and the water-dispersible resin (A) has a thermal melting temperature of 100° C. or lower.

Another embodiment of the disclosure relates to a thermal transfer sheet having a printing portion with a color ink having a color other than white and a printing portion with a white ink, wherein the white ink contains a water-dispersible resin (A) and water, and the water-dispersible resin (A) has a thermal melting temperature of 100° C. or lower.

Another embodiment of the disclosure is a method for producing a thermal transfer sheet, comprising: applying a color ink having a color other than white to a substrate sheet; and then applying a white ink by a wet-on-wet method, wherein the white ink contains a water-dispersible resin (A) and water, and the water-dispersible resin (A) has a thermal melting temperature of 100° C. or lower.

Another embodiment of the disclosure relates to a method for producing a transfer printed matter, comprising: overlapping the thermal transfer sheet described above on a fabric and heating to transfer an image; and peeling off a substrate sheet.

According to the disclosure, it is possible to provide a thermal transfer sheet with excellent image transferability, an ink set for a thermal transfer sheet, a method for producing a thermal transfer sheet, and a method for producing a transfer printed matter.

### DETAILED DESCRIPTION OF THE INVENTION

Hereinafter, embodiments of the disclosure will be described in detail, but the disclosure is not limited to these embodiments and various modifications and changes may be made.

An ink set for a thermal transfer sheet according to one embodiment (hereinafter sometimes referred to as “ink set”) includes a white ink and a color ink having a color other than white (hereinafter sometimes referred to as “non-white color ink”), the white ink contains a water-dispersible resin (A) and water, and the water-dispersible resin (A) has a thermal melting temperature of 100° C. or lower. In the ink set according to one embodiment, since the thermal melting temperature of the water-dispersible resin (A) contained in the white ink is 100° C. or lower, when producing a transfer printed matter using a thermal transfer sheet having an image formed with this ink set, the white ink is adequately penetrated into a fabric without using a hot melt powder, and an anchor effect can be obtained while maintaining the image quality of the transferred image, resulting in a thermal transfer sheet with excellent image transferability.

The water-dispersible resin (A) (hereinafter sometimes referred to as “resin (A)”) contained in the white ink is not particularly limited to the specific type of resins as long as it has a thermal melting temperature of 100° C. or lower, and various kinds of resins can be used. Furthermore, one of the resin (A) may be used alone, or a combination of two or more resin (A) may be used.

The thermal melting temperature of resin (A) is preferably 80° C. or lower, and more preferably 70° C. or lower, because the anchor effect on the fabric becomes more significant. Moreover, the thermal melting temperature of resin (A) is preferably 30° C. or higher, more preferably 40° C. or higher, and particularly preferably 50° C. or higher, because the balance between the anchor effect on the fabric and the image quality of the transferred image is excellent. The thermal melting temperature of resin (A) may be in the range of 30 to 100° C.

In the disclosure, the thermal melting temperature of the resin is a ½ method temperature calculated from the flow curve measured by a heating test using a high-viscosity flow tester according to JIS K7121:2012. Examples of the flow tester that can be used include a high-viscosity flow tester “CFT-500D” manufactured by Shimadzu Corporation.

Resin (A) is preferably a resin that can form a transparent coating film as it becomes a white ink with more excellent color development. Specific examples of resin (A) include conjugated diene-based resins such as styrene-butadiene copolymers, methyl methacrylate-butadiene copolymers, and vinyl chloride-vinyl acetate copolymers; acrylic resins such as polymers of acrylic acid esters and methacrylic acid esters, or copolymers of these with styrene or the like; vinyl-based resins such as ethylene-vinyl acetate copolymers; functionalized resins in which these various resins are modified with functional monomers such as carboxyl groups; melamine resins; urea resins; polyurethane resins; polyester resins; polyolefin resins; silicone resins; polyvinyl butyral resins; and alkyd resins. Among these, polyurethane resin is preferred due to its superior anchor effect on the fabric.

Examples of the water-dispersible resins having a thermal melting temperature of 100° C. or lower include “SUPERFLEX 500M” (thermal melting temperature 67° C.), “SUPERFLEX 740” (thermal melting temperature 53° C.), and “SUPERFLEX 860” (thermal melting temperature 93° C.) from DKS Co. Ltd.

The content of resin (A) in the white ink is preferably 5% by mass or more, more preferably 8% by mass or more, and particularly preferably 12% by mass or more in view of excellent image quality and wash fastness in transfer printed matters. The content may also be 30% by mass or less, 25% by mass or less, or 20% by mass or less. The content of resin (A) in the white ink may be in the range of 5 to 30% by mass.

Examples of the water contained in the white ink include ion-exchanged water, distilled water, and ultra-pure water. The water content in the white ink is adjusted as appropriate according to the desired viscosity, and for example it may be in the range of 30 to 90% by mass.

The white ink contains a white colorant. One colorant may be used alone, or a combination of two or more colorants may be used. Various white pigments can be used as the colorants, and examples of the white pigments include white inorganic pigments such as titanium oxide, zinc oxide, zinc sulfide, antimony oxide, and zirconium oxide. Among them, titanium oxide is preferably used from the viewpoint of opacity. The average particle diameter of titanium oxide is not particularly limited, and for example it may be in the range of 100 to 600 nm. In the white ink, a pigment dispersion in which a pigment has been pre-dispersed with a pigment dispersant may be used, or a pigment dispersion that has been dispersed with a pigment dispersant described later may be used.

The content of the white pigments in the white ink is not particularly limited and can be used in a range similar to that of general white inks. For example, it may be in the range of 1 to 30% by mass with respect to the total amount of white ink.

To stably disperse the white pigments in the white ink, various pigment dispersants may be used. One of the pigment dispersants may be used alone, or a combination of two or more pigment dispersants may be used. Examples of the pigment dispersants include polymer dispersants and surfactant-type dispersants, and the like.

Examples of the polymer dispersants include commercially available products such as the TEGO Disperse series from Evonik Industries AG (such as “TEGO Disperse 740W”, “TEGO Disperse 750W”, “TEGO Disperse 755W”, “TEGO Disperse 757W”, and “TEGO Disperse 760W”); the Solsperse series from Lubrizol Japan Limited (such as “Solsperse 20000”, “Solsperse 27000”, “Solsperse 41000”, “Solsperse 41090”, “Solsperse 43000”, “Solsperse 44000”, and “Solsperse 46000”); the Joncryl series from BASF Japan (such as “Joncryl 57”, “Joncryl 60”, “Joncryl 62”, “Joncryl 63”, “Joncryl 71”, and “Joncryl 501”); “DISPERBYK-102”, “DISPERBYK-185”, “DISPERBYK-190”, “DISPERBYK-193”, “DISPERBYK-199” and the like from BYK Japan KK; and “Polyvinylpyrrolidone K-30”, “Polyvinylpyrrolidone K-90” and the like from DKS Co. Ltd.

Examples of the surfactant-type dispersants include commercially available products such as the DEMOL series from Kao Corporation (such as “DEMOL P”, “DEMOL EP”, “DEMOL N”, “DEMOL RN”, “DEMOL NL”, “DEMOL RNL”, and “DEMOL T-45”) and other anionic surfactants; and the EMULGEN series from Kao Corporation (such as “EMULGEN A-60”, “EMULGEN A-90”, “EMULGEN A-500”, “EMULGEN B-40”, “EMULGEN L-40”, and “EMULGEN 420”) and other nonionic surfactants.

The amount of the pigment dispersant used is appropriately adjusted according to the type of the white pigment and the pigment dispersant, and, for example, it may be in the range of 0.05 to 20 parts by mass relative to 100 parts by mass of the white pigment.

The white ink may contain components other than the resin (A), water, and the white colorant. Examples of the other components include a surfactant, a water-soluble organic solvent a pH adjuster, a fixative, and a preservative, and the like.

Examples of the surfactants include anionic surfactants, cationic surfactants, amphoteric surfactants, and nonionic surfactants. Surfactants may be either low molecular weight compound-based surfactants or polymer-based surfactants. One of the surfactants may be used alone, or a combination of two or more surfactants may be used. Among them, nonionic surfactants are preferred. The HLB value of the surfactant is preferably between 10 and 20.

Examples of the nonionic surfactants include ester-based surfactants such as glycerol fatty acid esters and sorbitan fatty acid esters; ether-based surfactants such as polyoxyethylene alkyl ethers, polyoxyethylene alkyl phenyl ethers and polyoxypropylene alkyl ethers; ether-ester-based surfactants such as polyoxyethylene sorbitan fatty acid esters; acetylene-based surfactants; silicone-based surfactants; and fluorine-based surfactants.

Among these, in view of obtaining transfer images with higher image quality, it is preferable that the white ink contains a silicone-based surfactant. Examples of the silicone-based surfactants include polyether-modified silicone-based surfactants, alkyl-aralkyl-comodified silicone-based surfactants, and acrylic silicone-based surfactants. Examples of commercially available silicone-based surfactants include “Silface SAG002” and “Silface SAG503A” from Nissin Chemical Industry Co., Ltd.

The content of the silicone-based surfactant in the white ink may be, for example, 0.05% by mass or more, 0.1% by mass or more, or 0.5% by mass or more. The content may also be 10% by mass or less, 5% by mass or less, or 3% by mass or less. The content of the silicone-based surfactant in the white ink may be in the range of 0.05 to 10% by mass.

Moreover, in view of obtaining transfer printed matters having more excellent wash fastness, it is preferable that the white ink contains a polyoxyethylene alkyl ether. The number of repeating units of the oxyethylene chain in the polyoxyethylene alkyl ether may be 10 or more, 12 or more, or 16 or more. The number of repeating units may also be 30 or less, 28 or less, or 24 or less. The number of repeating units of the oxyethylene chain in the polyoxyethylene alkyl ether may be in the range of 10 to 30. The number of carbon atoms in the alkyl group of the polyoxyethylene alkyl ether may be 10 or more, 12 or more, or 14 or more. The number of carbon atoms may also be 30 or less, 26 or less, or 22 or less. The number of carbon atoms in the alkyl group of the polyoxyethylene alkyl ether may be in the range of 10 to 30.

The content of the polyoxyethylene alkyl ether in the white ink may be, for example, 0.05% by mass or more, 0.1% by mass or more, or 0.5% by mass or more. The content may also be 10% by mass or less, 8% by mass or less, or 5% by mass or less. The content of the polyoxyethylene alkyl ether in the white ink may be in the range of 0.05 to 10% by mass.

As the water-soluble organic solvents, those commonly used in the field of aqueous inks can be used without particular limitation. One of the water-soluble organic solvents may be used alone, or a combination of two or more water-soluble organic solvents may be used. Among them, the water-soluble organic solvents that are liquid at room temperature and can be uniformly mixed with an equal volume of water at 20° C. and 1 atmosphere are preferred. Examples of such water-soluble organic solvents include lower alcohol compounds such as methanol, ethanol, 1-propanol, isopropanol, 1-butanol, 2-butanol, isobutanol and 2-methyl-2-propanol; glycol compounds such as ethylene glycol, diethylene glycol, trimethylene glycol, triethylene glycol, tetraethylene glycol, propylene glycol, dipropylene glycol, and tripropylene glycol; glycerol compounds such as glycerol, diglycerol, and triglycerol; acetin compounds such as monoacetin, diacetin, and triacetin; glycol ether compounds such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; triethanolamine, 1-methyl-2-pyrrolidone, 1,3-dimethyl-2-imidazolidinone, β-thiodiglycol, and sulfolane.

The content of the water-soluble organic solvent in the white ink may be, for example, 1% by mass or more, 5% by mass or more, or 10% by mass or more. The content may also be 30% by mass or less, 25% by mass or less, or 20% by mass or less. The content of the water-soluble organic solvent in the white ink may be in the range of 1 to 30% by mass.

The method for producing the white ink is not particularly limited and can be produced by a general method for white ink. As an example, all components can be added at once or in parts to a stirrer such as a three-one motor to disperse them, and if desired, passed through a filtration device such as a membrane filter to obtain an ink.

The pH of the white ink may be in the range of 7.0 to 10.0 from the viewpoint of ink storage stability. When the white ink is an inkjet ink, its viscosity may be in the range of 1 to 30 mPa·s at 23° C. from the viewpoint of inkjet jet properties.

An ink set according to one embodiment includes a non-white color ink. The ink set may contain one or more types of non-white color inks.

The non-white color ink contains a non-white colorant. One colorant may be used alone, or a combination of two or more colorants may be used. Various non-white pigments can be used as colorants, and examples thereof include organic pigments such as azo pigments, phthalocyanine pigments, polycyclic pigments, and dye lake pigments, and inorganic pigments such as carbon blacks and metal oxides. Examples of the azo pigments include soluble azo lake pigments, insoluble azo pigments, and condensed azo pigments. Examples of the phthalocyanine pigments include metal phthalocyanine pigments and metal-free phthalocyanine pigments. Examples of the polycyclic pigments include quinacridone-based pigments, perylene-based pigments, perinone-based pigments, isoindoline-based pigments, isoindolinone-based pigments, dioxazine-based pigments, thioindigo-based pigments, anthraquinone-based pigments, quinophthalone-based pigments, metal complex pigments, and diketopyrrolopyrrole (DPP). Examples of the carbon black include furnace carbon black, lamp black, acetylene black, and channel black.

When the non-white color ink is an inkjet ink, the average particle diameter of the pigment particles may be 300 nm or less, 200 nm or less, or 150 nm or less as the average value based on volume in the particle size distribution measured by dynamic light scattering methods from the viewpoints of jetting stability and storage stability of the ink.

The non-white pigment may be a self-dispersing pigment and a microencapsulated pigment coated with a resin. In addition, in the non-white color ink, a pigment dispersion in which a pigment has been pre-dispersed with a pigment dispersant may be used, or a pigment may be dispersed for use with a pigment dispersant described later.

The self-dispersing pigment is a pigment in which a hydrophilic functional group has been introduced into the surface of the pigment by a chemical treatment or physical treatment. The hydrophilic functional group to be introduced into the self-dispersing pigment is preferably the one having ionicity. The pigment particles can be stably dispersed in water by electrostatic repulsive force by anionically or cationically charging the surface of the pigment. Examples of anionic functional groups include carboxyl groups, sulfonic groups, sulfino groups, sulfate ester groups, phosphate groups, phosphate ester groups, phosphonic groups, and phosphonic ester groups. Examples of cationic functional groups include quaternary ammonium groups and quaternary phosphonium groups. These hydrophilic functional groups may be directly bonded to the pigment surface or may be bonded through another atomic group. Examples of the atomic group include an alkylene group, a phenylene group, and a naphthylene group. Examples of the pigment surface treatment method include a diazotization treatment, a sulfonation treatment, a hypochlorous acid treatment, a humic acid treatment, and a vacuum plasma treatment.

Examples of the self-dispersing pigments include the “CAB-O-JET” series from Cabot Corporation (such as “CAB-O-JET200”, “CAB-O-JET300”, “CAB-O-JET250C”, “CAB-O-JET260M”, “CAB-O-JET270Y”, “CAB-O-JET450C”, and “CAB-O-JET465M”), and the “BONJET” series from ORIENT CHEMICAL INDUSTRIES CO., LTD. (such as “BONJET BLACK CW-1”, “BONJET BLACK CW-2”, “BONJET BLACK CW-3”, and “BONJET BLACK CW-4”).

Examples of the commercially available pigment dispersion in which a pigment has been pre-dispersed with a pigment dispersant include the HOSTAJET series manufactured by Clariant AG and the FUJI SP series manufactured by Fuji Pigment Co., LTD.

The content of the non-white pigments in the non-white color ink is not particularly limited and can be used in a range similar to that of general non-white color inks. For example, the content may be in the range of 1 to 10% by mass with respect to the total amount of the non-white color ink.

To stably disperse the non-white pigments in the non-white color ink, various pigment dispersants may be used. One of the pigment dispersants may be used alone, or a combination of two or more pigment dispersants may be used. Specific examples of the pigment dispersants include those exemplified in the description of the white ink.

It is preferable that the non-white color ink contains a resin. One resin may be used alone, or a combination of two or more resins may be used. The non-white color ink may be a water-based ink similarly to the white ink, and in that case, it is preferable to contain a water-dispersible resin (B) (hereinafter sometimes referred to as “resin (B)”) and water.

It is preferable that the thermal melting temperature of resin (B) is equal to or higher than that of resin (A), and more preferably it is higher than that of resin (A). By having the thermal melting temperature of resin (B) higher than that of resin (A), mixing between the white ink and the non-white color ink is difficult to occur during transfer, allowing for a transfer image with higher image quality to be obtained. The difference between the thermal melting temperature of resin (B) and the thermal melting temperature of resin (A) may be 0° C. or higher, 50° C. or higher, or 100° C. or higher. The difference may also be 200° C. or lower, 180° C. or lower, or 160° C. or lower. The difference between the thermal melting temperature of resin (B) and the thermal melting temperature of resin (A) may be in the range of 0 to 200° C.

Resin (B) is preferably a resin that can form a transparent coating film as it becomes a non-white color ink with more excellent color development. Specific examples of resin (B) include conjugated diene-based resins such as styrene-butadiene copolymers, methyl methacrylate-butadiene copolymers, and vinyl chloride-vinyl acetate copolymers; acrylic resins such as polymers of acrylic acid esters and methacrylic acid esters, or copolymers of these with styrene or the like; vinyl-based resins such as ethylene-vinyl acetate copolymers; functionalized resins in which these various resins are modified with functional monomers such as carboxyl groups; melamine resins; urea resins; polyurethane resins; polyester resins; polyolefin resins; silicone resins; polyvinyl butyral resins; and alkyd resins. Among these, polyurethane resin is preferred due to its excellent adhesion to white ink images.

Examples of the water-dispersible resins include the polyurethane dispersion “DAOTAN” series from DAICEL-ALLNEX LTD. (such as “DAOTAN TW6450”, “DAOTAN TW6460”, “DAOTAN TW6490”, and “DAOTAN VTW1262”); the “Impranil” series from Sumika Covestro Urethane Company, Ltd. (such as “Impranil DLP”, “Impranil DLP-R”, “Impranil DLV”, “Impranil DLI”, “Impranil 1016”, “Impranil 1116”, “Impranil DLS”, “Impranil DL1537”, “Impranil DL1554”, “Impranil DL1380”, “Impranil LP CGL 105”, “Impranil DLN-SD”, “Impranil LP DSB 1069”, and “Impranil DLN-W50”), the “SUPERFLEX” series from DKS Co. Ltd. (such as “SUPERFLEX 420”, “SUPERFLEX 150HS”, “SUPERFLEX 460”, “SUPERFLEX 470”, “SUPERFLEX E2000”, “SUPERFLEX 740”, “SUPERFLEX 500M”, “SUPERFLEX 300”, and “SUPERFLEX 860”); the “elitel” series from UNITIKA LTD. (such as “elitel KT9204” and “elitel KT8803”); the “NeoRez” series from DSM (such as “NeoRez R-966” and “NeoRez R-4000”); the “AQUACER” series from BYK (such as “AQUACER 507”); and the “Mowinyl” series from Japan Coating Resin co., ltd. (such as “Mowinyl 6750”, “Mowinyl 6751D”, “Mowinyl 6763”, “Mowinyl 6770”, and “Mowinyl 6775”).

The content of resin (B) in the non-white color ink is appropriately adjusted according to the type of pigment or the like, and may be, for example, 5% by mass or more, 8% by mass or more, or 10% by mass or more. The content may also be 30% by mass or less, 25% by mass or less, or 20% by mass or less. The content of resin (B) in the non-white color ink may be in the range of 5 to 30% by mass.

Examples of the water contained in the non-white color ink include ion-exchanged water, distilled water, and ultra-pure water. The water content in the non-white color ink is adjusted as appropriate according to the desired viscosity, and for example it may be in the range of 30 to 90% by mass.

The non-white color ink may contain components other than non-white colorants, resin (B), and water. Examples of the other components include a surfactant, a water-soluble organic solvent, a pH adjuster, a fixatives, and a preservative, and the like.

Specific examples of the surfactants include those exemplified in the description of the white ink. One of the surfactants may be used alone, or a combination of two or more surfactants may be used. Among these, it is preferable that the non-white color ink contains a silicone-based surfactant in view of obtaining transfer printed matters having more excellent image quality. Examples of the silicone-based surfactants include polyether-modified silicone-based surfactants, alkyl-aralkyl-comodified silicone-based surfactants, and acrylic silicone-based surfactants. Examples of commercially available silicone-based surfactants include “Silface SAG002” and “Silface SAG503A” from Nissin Chemical Industry Co., Ltd.

The content of the silicone-based surfactant in the non-white color ink may be, for example, 0.05% by mass or more, 0.1% by mass or more, or 0.5% by mass or more. The content may also be 10% by mass or less, 5% by mass or less, or 3% by mass or less. The content of the silicone-based surfactant in the non-white color ink may be in the range of 0.05 to 10% by mass.

Specific examples of the water-soluble organic solvents include those exemplified in the description of the white ink. One of the water-soluble organic solvents may be used alone, or a combination of two or more water-soluble organic solvents may be used. The content of the water-soluble organic solvent in the non-white color ink may be, for example, 1% by mass or more, 5% by mass or more, or 10% by mass or more. The content may also be 35% by mass or less, 30% by mass or less, or 25% by mass or less. The content of the water-soluble organic solvent in the non-white color ink may be in the range of 1 to 35% by mass.

The method for producing the non-white color ink is not particularly limited and can be produced by a method similar to that of the white ink.

The pH of the non-white color ink may be in the range of 7.0 to 10.0 from the viewpoint of ink storage stability. When the non-white color ink is an inkjet ink, its viscosity may be in the range of 1 to 30 mPa·s at 23° C. from the viewpoint of inkjet jet properties.

An ink set according to one embodiment may include, in addition to the white ink and the non-white color ink, a transparent ink, a pre-treatment liquid, a post-treatment liquid, and the like. The transparent ink, the pre-treatment liquid, and the post-treatment liquid each can be those commonly used, for example, in the field of water-based inkjet inks.

A thermal transfer sheet according to one embodiment is a thermal transfer sheet having a printing portion with a non-white color ink and a printing portion with a white ink, wherein the white ink contains a water-dispersible resin (A) and water, and the water-dispersible resin (A) has a thermal melting temperature of 100° C. or lower. In the thermal transfer sheet according to one embodiment, the thermal melting temperature of the resin (A) contained in the white ink is 100° C. or lower, which allows the printing portion with a white ink to have hot melt properties and moderately penetrate the fabric during thermal transfer, achieving an anchor effect while maintaining image reproducibility. As a result, it becomes possible to form a transfer image without lack even without using hot melt powder, and a transfer printed matter with excellent wash fastness can be obtained.

In the thermal transfer sheet, the white ink and the non-white color ink are the same as those mentioned above. That is, the printing portion with a non-white color ink and the printing portion with a white ink in the thermal transfer sheet can be formed by the ink set described above.

The thermal transfer sheet may have a hot melt powder layer, similar to a typical thermal transfer sheet. Examples of the hot melt powder that can be used include those commonly used as hot melt powders for DTF printing. On the other hand, as mentioned above, since the printing portion with a white ink in the thermal transfer sheet has hot melt properties, which serves a similar role to the hot melt powder layer, the thermal transfer sheet is not required to have a hot melt powder layer. That is, the thermal transfer sheet may be a hot melt powder-free type in which the thermal transfer sheet is free of hot melt powder.

A thermal transfer sheet according to one embodiment can be produced by the method for producing a thermal transfer sheet which is another embodiment. The method for producing a thermal transfer sheet according to one embodiment is a method for producing a thermal transfer sheet, including: applying a non-white color ink to a substrate sheet; and then applying a white ink by a wet-on-wet method, wherein the white ink contains a water-dispersible resin (A) and water, and the water-dispersible resin (A) has a thermal melting temperature of 100° C. or lower.

In the method for producing a thermal transfer sheet, the white ink and non-white color ink are the same as those mentioned above. That is, the thermal transfer sheet can be produced using the ink set described above.

The type of substrate sheet is not particularly limited, and for example, the substrate sheet is any one that is able to print using an ink set according to one embodiment, has resistance to pressure and temperature conditions during thermal transfer, and is able to be peeled off after transfer. Specific examples of the substrate sheet that can be used include those commonly used as substrate sheets for DTF printing. The printing surface of the substrate sheet may have a primer layer, an easy-peel layer, or the like.

Among substrate sheets, those having a primer layer containing a cationic resin are preferred because they excel in color development and yield high-quality transfer images. The primer layer may contain one cationic resin or two or more cationic resins. Examples of the cationic resins include cationic urethane resins, cationic acrylic resins, and polyallylamine-based resins. Specific examples of the polyallylamine-type resins include polyallylamine, polyallylamine sulfate, polyallylamine hydrochloride, allylamine-diallylamine copolymer, allylamine-diallylamine copolymer sulfate, allylamine-diallylamine copolymer hydrochloride, allylamine-dimethylallylamine copolymer, allylamine-dimethylallylamine copolymer sulfate, allylamine-dimethylallylamine copolymer hydrochloride, poly-diallylamine, poly-diallylamine sulfate, poly-diallylamine hydrochloride, polymethyl-diallylamine amide, polymethyl-diallylamine amide sulfate, polymethyl-diallylamine amide hydrochloride, poly-diallylamine sulfur dioxide copolymer, poly-diallylamine sulfur dioxide copolymer sulfate, poly-diallylamine sulfur dioxide copolymer hydrochloride, polymethyl-diallylamine sulfur dioxide copolymer, polymethyl-diallylamine sulfur dioxide copolymer sulfate, and polymethyl-diallylamine sulfur dioxide copolymer hydrochloride, and poly-dimethyldiallylammonium chloride.

It is preferable that the cationic resin contains a polyallylamine-based resin because they provide high homogeneity in image density and yield high-quality transfer images. Furthermore, it is preferable to use the polyallylamine-based resin in combination with a cationic acrylic resin. In this case, the proportion of the polyallylamine-based resin to the total mass of the polyallylamine-based resin and the cationic acrylic resin may be 1% by mass or more, 5% by mass or more, or 10% by mass or more. The proportion may also be 50% by mass or less, 30% by mass or less, or 20% by mass or less. The proportion of the polyallylamine-based resin to the total mass of the polyallylamine-based resin and the cationic acrylic resin may be in the range of 1 to 50% by mass.

The thickness of the primer layer on the substrate sheet may be, for example, in the range of 1 to 10 μm. The primer layer can be formed, for example, by applying a coating solution containing a cationic resin onto the substrate sheet and drying it.

The method of applying the non-white color ink onto the substrate sheet is not particularly limited, and the non-white color ink can be applied using various printing methods such as screen printing, roller printing, or inkjet printing. Among these, it may be preferable to apply using inkjet printing from the viewpoint of enabling efficient production of thermal transfer sheets and ease of controlling the amount of each component. The type of the inkjet method is not particularly limited, and the inkjet method may be any method such as piezoelectric, electrostatic, or thermal methods. The application of each ink and ink aggregation liquid by the inkjet method can be performed, for example, using a general inkjet printer, by jetting droplets from an inkjet head based on digital signals and allowing the jetted droplets to adhere to a fabric.

The amount of the non-white color ink applied can be appropriately adjusted according to the type of the substrate sheet, the design of the printed image and the like, and may be, for example, in the range of 5 to 50 g/m². When using a plurality of non-white color inks, each may be in the range of 5 to 50 g/m².

After applying the non-white color ink, a white ink is applied using a wet-on-wet method. In the wet-on-wet method, the white ink is applied without a specific drying process after applying the non-white color ink. The method of applying the white ink is not particularly limited and can be done in a manner similar to that of the non-white color ink.

The amount of the white ink applied can be appropriately adjusted according to the type of the substrate sheet, the design of the printed image, or the like, and may be, for example, in the range of 50 g/m² to 300 g/m². When the amount of the white ink applied is 50 g/m² or more, even when the transfer sheet does not have a hot melt powder layer, it is possible to obtain a transfer image without lack and having excellent image quality. Furthermore, when the amount of white ink applied is 120 g/m² or more, the whiteness of the white image and the wash fastness of the transfer printed matter become more excellent. When the amount of the white ink applied is 180 g/m² or less, the solid uniformity of the white image becomes more excellent.

In the method for producing a thermal transfer sheet, other materials may be used in addition to the non-white color ink and the white ink. Examples of the other materials include a pre-treatment liquid applied to the substrate sheet before applying the non-white color ink, a post-treatment liquid applied after applying the white ink, and a hot melt powder. As mentioned above, in the method for producing a thermal transfer sheet according to one embodiment, the hot melt powder is not essential and can be used optionally.

The method for producing a thermal transfer sheet may include a drying process. The drying process may be performed after the application of the white ink. When using a post-treatment liquid, the drying process may be performed after applying the post-treatment liquid. The drying temperature and drying time are optionally set, and for example, the drying may be performed in the range of 50 to 150° C. for about 10 seconds to 10 minutes. By drying, it is possible to remove 90% by mass or more of the solvent components such as water and water-soluble organic solvents contained in the non-white color ink and the white ink.

The method for producing a transfer printed matter according to one embodiment is a method for producing a transfer printed matter, including: overlapping the thermal transfer sheet described above on a fabric and heating to transfer an image; and peeling off a substrate sheet.

The fabric is not particularly limited and can be of various types. Examples of fibers constituting the fabric include natural fibers such as cotton, silk, wool, and linen; chemical fibers such as polyester, acryl, polyurethane, nylon, rayon, cupra, and acetate; and mixed yarns of these. Examples of the type of the fabric include woven fabrics, knitted fabrics, and non-woven fabrics.

Conditions such as pressure, temperature, and press time during transfer are appropriately adjusted according to the type of the fabric, but for example, the pressure condition may be in the range of 3 to 12 pr when using a heat press machine “Hotronix Fusion Heat Press” manufactured by Stahls Hotronix Inc., the temperature condition may be in the range of 90 to 160° C., and the press time may be in the range of 5 to 30 seconds.

After transferring the image, it is preferable to cool the transfer printed matter to room temperature before peeling off the substrate sheet.

Several embodiments of the disclosure are shown below.

<1> An ink set for a thermal transfer sheet, comprising: a white ink; and a color ink having a color other than white, wherein the white ink contains a water-dispersible resin (A) and water, and the water-dispersible resin (A) has a thermal melting temperature of 100° C. or lower.

<2> The ink set for a thermal transfer sheet according to <1>, wherein the thermal melting temperature of the water-dispersible resin (A) is 40° C. or higher.

<3> The ink set for a thermal transfer sheet according to <1> or <2>, wherein the color ink having a color other than white contains a water-dispersible resin (B) and water, and a thermal melting temperature of the water-dispersible resin (B) is equal to or higher than the thermal melting temperature of the water-dispersible resin (A).

<4> The ink set for a thermal transfer sheet according to any one of <1> to <3>, wherein the white ink contains, in addition to the water-dispersible resin (A) and water, a silicone-based surfactant.

<5> The ink set for a thermal transfer sheet according to any one of <1> to <4>, wherein the white ink contains, in addition to the water-dispersible resin (A) and water, a water-soluble polyoxyethylene alkyl ether.

<6> A thermal transfer sheet having a printing portion with a color ink having a color other than white and a printing portion with a white ink, wherein the white ink contains a water-dispersible resin (A) and water, and the water-dispersible resin (A) has a thermal melting temperature of 100° C. or lower.

<7> The thermal transfer sheet according to <6>, which is free of hot melt powder.

<8> A method for producing a thermal transfer sheet, comprising: applying a color ink having a color other than white to a substrate sheet; and then applying a white ink by a wet-on-wet method, wherein the white ink contains a water-dispersible resin (A) and water, and the water-dispersible resin (A) has a thermal melting temperature of 100° C. or lower.

<9> The method for producing a thermal transfer sheet according to <8>, wherein the substrate sheet has a primer layer containing a cationic resin.

<10> The method for producing a thermal transfer sheet according to <8> or <9>, wherein the thermal transfer sheet is free of hot melt powder.

<11> A method for producing a transfer printed matter, comprising: overlapping the thermal transfer sheet according to <6> and <7> on a fabric and heating to transfer an image; and peeling off a substrate sheet.

### Examples

The embodiments of the disclosure are described below in further detail based on a series of Examples. The disclosure is not limited to only these Examples. Unless specifically stated otherwise, “%” represents “% by mass”. The contents shown in each table are indicated by the total amount of the raw materials blended as a solution, a dispersion, or the like.

In the present Example, the thermal melting temperature of the resin is a ½ method temperature calculated from the flow curve measured by a heating test using a high-viscosity flow tester “CFT-500D” manufactured by Shimadzu Corporation according to JIS K7121:2012.

### [Production of Ink Set for Thermal Transfer Sheet]

White inks (1) to (4) and (1′) and non-white color inks (1) to (8) were produced in the following manner, and these were combined to form an ink set for a thermal transfer sheet.

### [Production of White Ink]

Raw materials were mixed in the blending ratio described in Table 1, filtered through a cellulose acetate membrane filter having a pore size of 3 μm to obtain white inks (1) to (4) and (1′).

TABLE 1

| White ink | | (1) | (2) | (3) | (4) | (1′) |
|---|---|---|---|---|---|---|
| White pigment dispersion | [parts by | 22.9 | 22.9 | 22.9 | 22.9 | 22.9 |
| (pigment content 35% by | mass] | | | | | |
| mass) | | | | | | |
| Water-dispersible resin | [parts by | 33.3 | 22.2 | | 33.0 | |
| (A-1) (resin content | mass] | | | | | |
| 45% by mass) | | | | | | |
| Water-dispersible resin | [parts by | | | 37.5 | | |
| (A-2) (resin content | mass] | | | | | |
| 40% by mass) | | | | | | |
| Water-dispersible resin | [parts by | | 15.6 | 15.6 | | 46.9 |
| (A′) (resin content | mass] | | | | | |
| 32% by mass) | | | | | | |
| Silicone-based | [parts by | 1.0 | 1.0 | 1.0 | 1.0 | 1.0 |
| surfactant | mass] | | | | | |
| Polyoxyethylene alkyl | [parts by | | | | 2.0 | |
| ether | mass] | | | | | |
| Water-soluble organic | [parts by | 15.0 | 15.0 | 15.0 | 15.0 | 15.0 |
| solvent (diethylene | mass] | | | | | |
| glycol) | | | | | | |
| Ion-exchanged water | [parts by | 27.8 | 23.3 | 8.0 | 26.1 | 14.2 |
| | mass] | | | | | |
| Total | [parts by | 100.0 | 100.0 | 100.0 | 100.0 | 100.0 |
| | mass] | | | | | |

The details of the raw materials listed in Table 1 are as follows.
White pigment dispersion: a dispersion obtained by using 350 g of titanium oxide (“R62N” from SAKAI CHEMICAL INDUSTRY CO., LTD.) and 14 g of pigment dispersant (“DEMOL EP” from Kao Corporation, effective component 3.5 g) as a white pigment, mixing the white pigment with 636 g of ion-exchanged water, and dispersing using a bead mill (“DYNO-MILL KDL A type” from SHINMARU ENTERPRISES CORPORATION) with 0.5 mmΦ zirconia beads at an 80% filling rate and a residence time of 2 minutes. Pigment content 35% by mass
Water-dispersible resin (A-1): “SUPERFLEX 500M” from DKS Co. Ltd., a water-dispersed urethane resin having a thermal melting temperature of 67° C., resin content 45% by mass
Water-dispersible resin (A-2): “SUPERFLEX 740” from DKS Co. Ltd., a water-dispersed urethane resin having a thermal melting temperature of 53° C., resin content 40% by mass
Water-dispersible resin (A′): “SUPERFLEX 420” from DKS Co. Ltd., a water-dispersed urethane resin having a thermal melting temperature of 205° C., resin content 32% by mass
Silicone-based surfactant: “Silface SAG503A” manufactured by Nissin Chemical Industry Co., Ltd., HLB value 11
Polyoxyethylene alkyl ether: “NIKKOL BS-20” from Nikko Chemicals Co., Ltd., water-soluble polyoxyethylene stearyl ether, with 20 repeating units of oxyethylene chain, HLB value 18, melting point 68° C.

### [Production of Non-White Color Ink]

The raw materials were mixed in the ratio described in Table 2 and filtered through a cellulose acetate membrane filter having a pore size of 3 μm to obtain non-white color inks (1) to (8).

TABLE 2

| Non-white ink | | (1) | (2) | (3) | (4) | (5) | (6) | (7) | (8) |
|---|---|---|---|---|---|---|---|---|---|
| Black pigment dispersion | [parts by mass] | 20.0 | | | | 20.0 | | | |
| (pigment content 15% by mass) | | | | | | | | | |
| Cyan pigment dispersion (pigment | [parts by mass] | | 30.0 | | | | 30.0 | | |
| content 10% by mass) | | | | | | | | | |
| Magenta pigment dispersion | [parts by mass] | | | 30.0 | | | | 30.0 | |
| (pigment content 10% by mass) | | | | | | | | | |
| Yellow pigment dispersion | [parts by mass] | | | | 30.0 | | | | 30.0 |
| (pigment content 10% by mass) | | | | | | | | | |
| Water-dispersible resin (B-1) | [parts by mass] | 31.3 | 31.3 | 31.3 | 31.3 | | | | |
| (resin content 32% by mass) | | | | | | | | | |
| Water-dispersible resin (B-2) | [parts by mass] | | | | | 22.2 | 22.2 | 22.2 | 22.2 |
| (resin content 45% by mass) | | | | | | | | | |
| Silicone-based surfactant | [parts by mass] | 1.0 | 1.0 | 1.0 | 1.0 | 1.0 | 1.0 | 1.0 | 1.0 |
| Water-soluble organic solvent | [parts by mass] | 20.0 | 20.0 | 20.0 | 20.0 | 20.0 | 20.0 | 20.0 | 20.0 |
| (diethylene glycol) | | | | | | | | | |
| Ion-exchanged water | [parts by mass] | 27.7 | 17.7 | 17.7 | 17.7 | 36.8 | 26.8 | 26.8 | 26.8 |
| Total | [parts by mass] | 100.0 | 100.0 | 100.0 | 100.0 | 100.0 | 100.0 | 100.0 | 100.0 |

The details of the raw materials listed in Table 2 are as follows.
Black pigment dispersion: “CAB-O-JET 300” manufactured by Cabot Corporation, pigment content 15% by mass
Cyan pigment dispersion: “CAB-O-JET 250C” manufactured by Cabot Corporation, pigment content 10% by mass
Magenta pigment dispersion: “CAB-O-JET 260M” manufactured by Cabot Corporation, pigment content 10% by mass
Yellow pigment dispersion: “CAB-O-JET 270Y” manufactured by Cabot Corporation, pigment content 10% by mass
Water-dispersible resin (B-1): DKS Co. Ltd. “SUPERFLEX 420”, a water-dispersed urethane resin having a thermal melting temperature of 205° C., resin content 32% by mass
Water-dispersible resin (B-2): DKS Co. Ltd. “SUPERFLEX 500M”, a water-dispersed urethane resin having a thermal melting temperature of 67° C., resin content 45% by mass
Silicone-based surfactant: “Silface SAG503A” manufactured by Nissin Chemical Industry Co., Ltd., HLB value 11

### [Substrate Sheet]

The following two substrate sheets were used.
Substrate sheet (1): DTF printing film manufactured by TOYO Corporation
Substrate sheet (2): On the substrate sheet (1), a mixture of 90.3 parts by mass of cationic acrylic resin (“NS-625XC” manufactured by Takamatsu Oil & Fat Co., Ltd., resin content 12% by mass) and 9.7 parts by mass of polyallylamine (“PAA-01” manufactured by NITTOBO MEDICAL CO., LTD., resin content 15% by mass) was applied and dried to form a primer layer with a thickness of 6 μm.

### [Production of Thermal Transfer Sheet]

Non-white color ink and white ink were applied in order by a wet-on-wet method on the substrate sheet. The application of ink was performed by inkjet printing using an inkjet printer manufactured by MASTERMIND CO., LTD. The non-white color ink was applied as full-color image printing, while the white ink was applied as solid image printing. The printed image used had a portion without the application of non-white color ink and included a solid image portion of white ink (hereinafter referred to as “white solid image”). Subsequently, it was dried in a constant temperature chamber to evaporate 96% by mass of the solvent component, resulting in a thermal transfer sheet. The type of ink used, the amount of ink applied, and the drying temperature and time are shown in Table 3.

### [Production and Evaluation of Transfer Printed Matters]

On a black polyester T-shirt “Glimmer” manufactured by TOMS CO., LTD., the printed surface of the obtained thermal transfer sheet was overlapped, and heat-pressing was performed using a heat press machine “Hotronix Fusion Heat Press” manufactured by Stahls Hotronix Inc. under the conditions of pressure setting 9 pr, 140° C., for 20 seconds. After cooling to room temperature, the substrate sheet was peeled off to obtain a transfer printed matter. The following evaluation tests were conducted on the transfer printed matter. The results are shown in Table 3.

### [Evaluation of Image Transferability]

The transfer image of the transfer printed matter was visually observed, and the presence or absence of lack was evaluated based on the following criteria.
A: No lack in the image
B: Some lack in the image
C: The image is not transferred at all

### [Image Quality Evaluation 1: Color Development of Non-White Image]

The non-white image of the transfer printed matter was visually observed and evaluated based on the following criteria.
A: The color development is high and the color reproducibility of the printed image is high.
B: The color development is somewhat high, and a decrease in color reproducibility is observed in only part of the printed image.
C: The color development is low, and a mixture of non-white color ink and white ink is observed throughout the image.

### [Image Quality Evaluation 2: Whiteness of White Image]

The white solid image of the transfer printed matter was visually observed and evaluated based on the following criteria.
A: The whiteness is very high, and the black color of the T-shirt is completely not visible.
B: The whiteness is high, and the black color of the T-shirt is somewhat visible.
C: The whiteness is overall low, and the black color of the T-shirt is visible.

### [Image Quality Evaluation 3: Solid Uniformity of White Image]

The white solid image of the transfer printed matter was visually observed and evaluated based on the following criteria.
AA: The solid uniformity is very high, and the entire white solid image is a homogeneous white.
A: The solid uniformity is high, some unevenness is present, but the entire white solid image is almost homogeneous white.
B: The solid uniformity is somewhat high, some unevenness is present, but the image can be recognized as a white image.
C: The solid uniformity is low, and unevenness is noticeable.

### [Evaluation of Wash Fastness of Transfer Printed Matter]

The transfer printed matter was washed according to the AATCC 61 2A standard and evaluated based on the following criteria.
AA: Wash fastness level 4.5 or higher
A: Wash fastness level 4
B: Wash fastness level 2.5 to 3.5
C: Wash fastness level 2.0 or lower

TABLE 3

| | Example 1 | Example 2 | Example 3 | Example 4 | Example 5 |
|---|---|---|---|---|---|
| Substrate sheet | (1) | (1) | (1) | (1) | (1) |
| Type of non-white ink | (1)-(4) | (5)-(8) | (1)-(4) | (1)-(4) | (1)-(4) |
| Amount of non-white ink applied [g/m²] | Each 20 | Each 20 | Each 20 | Each 20 | Each 20 |
| Thermal melting temperature of resin (B) [° C.] | 205 | 67 | 205 | 205 | 205 |
| Type of white ink | (1) | (1) | (2) | (3) | (4) |
| Amount of white ink applied [g/m²] | 150 | 150 | 150 | 150 | 150 |
| Thermal melting temperature of resin (A) [° C.] | 67 | 67 | 67 | 53 | 67 |
| Drying temperature [° C.] | 110 | 110 | 110 | 110 | 110 |
| Drying time [min] | 5 | 5 | 5 | 5 | 5 |
| Image transferability | A | A | A | A | A |
| Color development of non-white image | A | B | A | A | A |
| Whiteness of white image | A | A | A | A | A |
| Solid uniformity of white image | A | A | A | A | A |
| Wash fastness | A | A | B | A | AA |
| | | | | | Comparative |
| | Example 6 | Example 7 | Example 8 | Example 9 | Example 1 |
| Substrate sheet | (1) | (1) | (2) | (1) | (1) |
| Type of non-white ink | (1)-(4) | (1)-(4) | (1)-(4) | (1)-(4) | (1)-(4) |
| Amount of non-white ink applied [g/m²] | Each 20 | Each 20 | Each 20 | Each 20 | Each 20 |
| Thermal melting temperature of resin (B) [° C.] | 205 | 205 | 205 | 205 | 205 |
| Type of white ink | (1) | (1) | (1) | (1) | (1′) |
| Amount of white ink applied [g/m²] | 100 | 200 | 150 | 150 | 150 |
| Thermal melting temperature of resin (A) [° C.] | 67 | 67 | 67 | 67 | 205 |
| Drying temperature [° C.] | 110 | 110 | 110 | 110 | 110 |
| Drying time [min] | 5 | 5 | 5 | 2 | 5 |
| Image transferability | A | A | A | A | C |
| Color development of non-white image | A | A | A | A | — |
| Whiteness of white image | B | A | A | B | — |
| Solid uniformity of white image | A | B | AA | B | — |
| Wash fastness | B | A | A | A | — |

In Examples 1 to 9 in which the white ink contained resin (A), a transfer image without lack could be formed. On the other hand, in Comparative Example 1, where the resin contained in the white ink has a thermal melting temperature exceeding 100° C., a transfer image could not be obtained.

In Example 5 in which the white ink contained a water-soluble polyoxyethylene alkyl ether, a transfer printed matter with excellent wash fastness compared to other Examples was obtained.

In Example 8 in which a substrate sheet (2) having a primer layer containing a cationic resin as a substrate sheet was used, the solid uniformity of the white image was more excellent compared to other Examples.

1. An ink set for a thermal transfer sheet, comprising: a white ink; and a color ink having a color other than white, wherein
the white ink contains a water-dispersible resin (A) and water, and
the water-dispersible resin (A) has a thermal melting temperature of 100° C. or lower.

2. The ink set for a thermal transfer sheet according to claim 1, wherein the thermal melting temperature of the water-dispersible resin (A) is 40° C. or higher.

3. The ink set for a thermal transfer sheet according to claim 1, wherein the color ink having a color other than white contains a water-dispersible resin (B) and water, and a thermal melting temperature of the water-dispersible resin (B) is higher than the thermal melting temperature of the water-dispersible resin (A).

4. The ink set for a thermal transfer sheet according to claim 1, wherein the white ink further contains a silicone-based surfactant.

5. The ink set for a thermal transfer sheet according to claim 1, wherein the white ink further contains a water-soluble polyoxyethylene alkyl ether.

6. The ink set for a thermal transfer sheet according to claim 1, wherein the thermal melting temperature of the water-dispersible resin (A) is 40° C. or higher and 100° C. or lower, and the white ink further contains a silicone-based surfactant and a water-soluble polyoxyethylene alkyl ether.

7. The ink set for a thermal transfer sheet according to claim 3, wherein the thermal melting temperature of the water-dispersible resin (A) is 40° C. or higher and 100° C. or lower, and the white ink further contains a silicone-based surfactant and a water-soluble polyoxyethylene alkyl ether.

8. A thermal transfer sheet comprising: a printing portion formed with a color ink having a color other than white; and a printing portion formed with a white ink, wherein
the white ink contains a water-dispersible resin (A) and water, and
the water-dispersible resin (A) has a thermal melting temperature of 100° C. or lower.

9. The thermal transfer sheet according to claim 8, which is free of hot melt powder.

10. The thermal transfer sheet according to claim 8, wherein the thermal melting temperature of the water-dispersible resin (A) is 40° C. or higher and 100° C. or lower, the white ink further contains a silicone-based surfactant and a water-soluble polyoxyethylene alkyl ether, the color ink having a color other than white contains a water-dispersible resin (B) and water, and a thermal melting temperature of the water-dispersible resin (B) is higher than the thermal melting temperature of the water-dispersible resin (A).

11. The thermal transfer sheet according to claim 9, wherein the thermal melting temperature of the water-dispersible resin (A) is 40° C. or higher and 100° C. or lower, the white ink further contains a silicone-based surfactant and a water-soluble polyoxyethylene alkyl ether, the color ink having a color other than white contains a water-dispersible resin (B) and water, and a thermal melting temperature of the water-dispersible resin (B) is higher than the thermal melting temperature of the water-dispersible resin (A).

12. A method for producing a thermal transfer sheet, comprising: applying a color ink having a color other than white to a substrate sheet; and then applying a white ink by a wet-on-wet method, wherein
the white ink contains a water-dispersible resin (A) and water, and
the water-dispersible resin (A) has a thermal melting temperature of 100° C. or lower.

13. The method for producing a thermal transfer sheet according to claim 12, wherein the thermal melting temperature of the water-dispersible resin (A) is 40° C. or higher and 100° C. or lower, the white ink further contains a silicone-based surfactant and a water-soluble polyoxyethylene alkyl ether, the color ink having a color other than white contains a water-dispersible resin (B) and water, and a thermal melting temperature of the water-dispersible resin (B) is higher than the thermal melting temperature of the water-dispersible resin (A).

14. The method for producing a thermal transfer sheet according to claim 12, wherein the substrate sheet has a primer layer containing a cationic resin.

15. The method for producing a thermal transfer sheet according to claim 12, wherein the thermal transfer sheet is free of hot melt powder.

16. A method for producing a transfer printed matter, comprising: overlapping the thermal transfer sheet according to claim 8 on a fabric and heating to transfer an image; and peeling off a substrate sheet.

17. A method for producing a transfer printed matter, comprising: overlapping the thermal transfer sheet according to claim 9 on a fabric and heating to transfer an image; and peeling off a substrate sheet.
